(19) United States
(12) Patent Application Publication
(10) Pub. No.: US 2026/0148256 A1
(43) Pub. Date: May 28, 2026

(54) IDENTIFYING AUDIENCE INSIGHTS BASED ON PERSONA REPRESENTATIONS USING ARTIFICIAL INTELLIGENCE

(71) Applicant: Adobe Inc., San Jose, CA (US)

(72) Inventors: Ritwik SINHA, Cupertino, CA (US); Baldo FAIETA, San Francisco, CA (US); Viswanathan SWAMINATHAN, Saratoga, CA (US)

(21) Appl. No.: 18/957,341

(22) Filed: Nov. 22, 2024

(51) Int. Cl. G06Q 30/0242; G06Q 30/0251

(52) U.S. Cl. CPC G06Q 30/0243; G06Q 30/0269

(57) ABSTRACT

Methods, computer systems, computer storage media, and graphical user interfaces are provided for facilitating identification of audience insights based on persona representations using AI. In one implementation, a persona representation associated with a target audience is identified for a campaign asset. Thereafter, via one or more generative artificial intelligence (AI) models, an audience insight is determined in relation to the campaign asset based on the persona representation associated with the target audience. The audience insight may be displayed in relation to the campaign asset.

### BACKGROUND

Oftentimes, a number of campaign variations may be created. For example, campaign variations may be created to target a particular audience group (e.g., age, location, interests, etc.) and, as such, to optimize for a more effective campaign. To determine which campaign variation would be most effective to attain a particular goal, each variation may be examined in relation to the particular goal. For example, assume different content variations are created for a product. To determine which content variation to use in association with a campaign, the different content variations may be tested in the market by measuring the success or obtaining feedback. Such a process is time-consuming and tedious. For example, in some cases, a campaign variation may be tested for several months in order to determine success of the campaign variation. With the use of artificial intelligence (AI) available to create an extensive amount of content variations, the quantity of content variations to analyze may be unduly burdensome and extensive in time duration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating identification of audience insights based on persona representations using AI. In particular, embodiments are directed to an automated manner for identifying audience insights in association with campaign assets based on persona representations. In this way, audience insights associated with a campaign asset(s) may be identified in an efficient manner for any number of campaign variations (e.g., content variations), thereby enabling identification of a campaign variation more likely to attain a particular goal. Persona representations generally reflect or represent a persona (e.g., actual or synthetic) of an individual. In some cases, persona representations are generated automatically based on analysis of customer data, for example, identified by an organization. Upon obtaining or identifying an objective or goal associated with a campaign, a set of persona representations may be identified. For example, assume a campaign goal is to increase revenue for a particular product in a particular geographic area. In such a case, persona representations associated with the particular geographic area may be identified. The identified persona representations may then be provided to AI technology (e.g., a Large Language Model [LLM]) along with a campaign asset (e.g., content) to identify any audience insights associated with the campaign asset. For example, a prompt may be generated that includes a campaign image along with one or more persona representations and an instruction to identify whether a particular product is of interest to the persona representation based on the campaign image. In some cases, the audience insights may indicate an interest in a product or an indication of resonation with a campaign asset. Additionally or alternatively, the audience insights may provide any type of feedback in relation to a campaign (e.g., why is the product of interest, etc.). In some cases, an audience insight(s) may be represented for a group of persona representations. In other cases, an audience insight(s) may be represented for a particular persona representation. Using AI technology, such as an LLM, audience insights can be identified for various campaign asset variations in association with various persona representations in an efficient and timely manner.

### BRIEF DESCRIPTION OF THE DRAWINGS

The technology described herein is described in detail below with reference to the attached drawing figures, wherein:

FIG. 1 is a block diagram of an exemplary system for identifying audience insights based on persona representations using AI, suitable for use in implementing aspects of the technology described herein;

FIG. 2 is an example implementation for facilitating identification of audience insights based on persona representations using AI, in accordance with aspects of the technology described herein;

FIG. 3 provides an example method for facilitating identification of audience insights based on persona representations using AI, in accordance with embodiments described herein;

FIG. 4 provides another example method for facilitating identification of audience insights based on persona representations using AI, in accordance with embodiments described herein;

FIG. 5 provides another example method for facilitating identification of audience insights based on persona representations using AI; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Campaign variations may be created in an effort to effectuate a more effective campaign. For instance, assume a particular goal for a campaign is determined or designated. In such a case, campaign variations may be created in an effort to identify a most suitable approach or campaign asset to use in an effort to achieve the particular goal. For example, various content items may be created to identify which content resonates most with a target audience. To determine which content variation to use in association with a campaign, the different content variations may be tested in the market by measuring the success or obtaining feedback. Such a process is time-consuming and tedious. For example, in some cases, a campaign variation may be tested for several months in order to determine success of the campaign variation. Such results may then be manually analyzed to determine which campaign variation is most likely to attain the designated goal. With the use of artificial intelligence (AI) available to create an extensive amount of content variations, the quantity of content variations to analyze may be unduly burdensome and extensive in time duration.

Accordingly, unnecessary computing resources are utilized to analyze the campaign variations generated in accordance with a campaign. For example, computing and network resources are unnecessarily consumed in an effort to facilitate providing the campaign variations to individuals such that success and/or feedback associated with the campaign variations may be analyzed. For instance, computer input/output operations are unnecessarily increased in order to initiate provision of multiple campaign asset variations (e.g., content variations) to different users over an extended amount of time in order to evaluate success of the different campaign asset variations as each campaign asset variation requires a significant amount of computer input/output operations related to serving the corresponding campaign asset variation. Further, as campaign assets are communicated over a network, initiating multiple campaign assets over an extended period of time to obtain feedback on the corresponding campaign assets decreases the throughput for the network, increases the network latency, and increases packet generation costs. Additionally, analyzing the feedback in relation to the multiple campaign assets unnecessarily consumes computing resources. For example, the feedback results must be stored for the duration of the test period for many different campaign variations. As another example, the feedback results may be manually analyzed and/or analyzed throughout the duration of the test period, thereby unnecessarily consuming computing and network resources.

As such, embodiments described herein are directed to facilitating identification of audience insights based on persona representations using AI (e.g., generative AI), such as a large language model(s) (LLM), a large vision model(s) (LVM), and/or a multimodal large language model(s) (MLLM). In particular, embodiments are directed to an automated manner for identifying audience insights in association with campaign assets based on persona representations. In this way, audience insights associated with a campaign asset(s) may be identified in an effective and efficient manner for any number of campaign variations (e.g., content variations), thereby enabling evaluation of campaign variations, for example, to identify a campaign variation more likely to attain a particular goal. As such, campaign assets, such as content, may be efficiently and effectively analyzed or evaluated in reference to a desired or target audience.

At a high level, persona representations are generally generated to reflect or represent personas (e.g., actual or synthetic) of individuals or clusters of individuals. In some cases, persona representations are generated automatically based on analysis of customer data, for example, identified by an organization. Upon obtaining or identifying an objective or goal associated with a campaign, a particular set of persona representations may be identified. For example, assume a campaign goal is to increase revenue for a particular product in a particular geographic area. In such a case, persona representations associated with the particular geographic area may be identified. The identified persona representations may then be provided to AI technology (e.g., an LLM) along with a campaign asset (e.g., content) to identify any audience insights associated with the campaign asset. For example, a prompt may be generated that includes a campaign image along with one or more persona representations and an instruction to identify whether a particular product is of interest to the persona representation based on the campaign image. In some cases, the audience insights may indicate an interest in a product or an indication of resonation with a campaign asset. Additionally or alternatively, the audience insights may provide any type of feedback in relation to a campaign (e.g., why is the product of interest, etc.). In some cases, an audience insight(s) may be represented for a group of persona representations. In other cases, an audience insight(s) may be represented for a particular persona representation. Using AI technology, such as an LLM, audience insights can be identified for various campaign asset variations in association with various persona representations in an efficient and timely manner.

Advantageously, various campaign assets can be evaluated in association with various persona representations (e.g., that align with a goal or objective). In this way, an extensive amount of candidate content created may be efficiently and effectively analyzed to identify audience insights in relation to the various content, such as whether content is effective in attaining a designated goal. As such, a more timely approach can be used to analyze multiple campaign assets for effectiveness of the campaign assets in attaining a goal.

Further, embodiments described herein provide a scalable, timely, and efficient solution. In particular, using AI techniques, such as an LLM, LVM, and/or MLLM, enables an efficient identification of campaign assets that are likely to result in success. Further, as modification(s) to a campaign asset is proposed or occurs, AI techniques may be used for timely evaluation of the modification(s). In this way, campaign asset evaluation is performed in a timely and consistent manner to account for numerous variations in association with a target audience.

In addition, embodiments described herein provide an enhanced and intuitive user experience. In particular, in accordance with selecting to evaluate a campaign asset(s), the user is presented with helpful and accurate audience insights. For example, various audience insights may indicate that a candidate content successfully attains a campaign goal or objective, a candidate content unsuccessfully attains a campaign goal or objective, a ranking of candidate contents, a score indicating an extent of achievement of a goal, and/or the like. In this way, suitable campaign assets are timely identified and may be more efficiently implemented to achieve designated goals.

Advantageously, efficiencies of computing and network resources can be enhanced using implementations described herein. In particular, using persona representations in association with AI technology provides for a more efficient use of computing resources (e.g., less computationally expensive, fewer input/output operations, higher throughput and reduced latency for a network, fewer packet generation costs, etc.) than conventional methods that require an extensive duration for testing and a manual analysis of such test results, which is exacerbated with the extensive amount of content that can be created using AI technology. In this regard, the technology described herein enables identification of audience insights based on persona representations using AI (e.g., generative AI) in an efficient and effective manner, thereby reducing unnecessary computing resources used to initiate multiple campaign assets. Further, the technology described herein conserves network resources, as campaign assets need not be served to an extensive number of individuals over a lengthy duration of time to evaluate the campaign assets, which results in higher throughput, reduced latency, and lower packet generation costs as fewer packets are sent over the network.

Various terms are used throughout the description of embodiments provided herein. A brief overview of such terms and phrases is provided here for ease of understanding, but more details of these terms and phrases are provided throughout.

A campaign generally refers to a plan or set of actions and messages designed to achieve a particular goal or objective. In embodiments, the goal may be related to a financial or marketing goal, such as raising awareness, promoting a product or service, increasing sales, encouraging a particular behavior or outcome, etc. A campaign may be captured in a campaign brief. A campaign or a campaign brief may include various campaign data or elements to reflect the plan or set of actions and messages.

Campaign data includes any associated with a campaign. Such campaign data may be captured in a campaign brief that describes the campaign. Examples of campaign data include a goal(s), a target audience(s), a message(s), a channel(s), a tactic(s), a measurement(s), a campaign asset(s), etc. A goal generally refers to a main purpose or objective associated with the campaign. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset.

A campaign asset may include any asset or material related to a campaign. Generally, a campaign asset may include material or messaging provided to an audience or individuals to engage, persuade, and/or encourage an action. A campaign asset may take on any of a number of forms. In embodiments, a campaign asset is in the form of a content item, such as an image and/or text, that conveys or portrays a message, product, item, etc. Examples of campaign assets include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), and videos. In some cases, a campaign asset is included in a campaign. For example, a campaign brief may indicate or include a campaign asset. Additionally or alternatively, a campaign asset may be a candidate asset for including in a campaign that is not necessarily included in the campaign but is a potential asset for including in the campaign. For example, various content may be generated as possible content to convey to individuals.

A persona representation generally refers to a representation or profile of a persona that indicates or characterizes an individual or set of individuals. A persona representation may include a representation of various attributes, such as particular traits, behaviors, and/or characteristics that define how a person or hypothetical person is perceived. For example, a persona representation may include various attributes related to demographic information (e.g., age, gender, geographical location, income, job role, and education level), psychographics (e.g., values, interests, lifestyle, and personality traits), behavioral insights (e.g., purchasing habits, product preference, and brand interaction patterns), goals and motivation (e.g., what drives engagement with or purchasing of a product), problems or challenges (e.g., that the product or service aims to solve), etc.

Customer data generally refers to any data regarding a customer or customers. Customer data within a dataset may include, by way of example and not limitation, data that is sensed or determined from one or more sensors, such as location information of a mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; or other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

### Overview of Exemplary Environments for Facilitating Identification of Audience Insights Based on Persona Representations Using AI

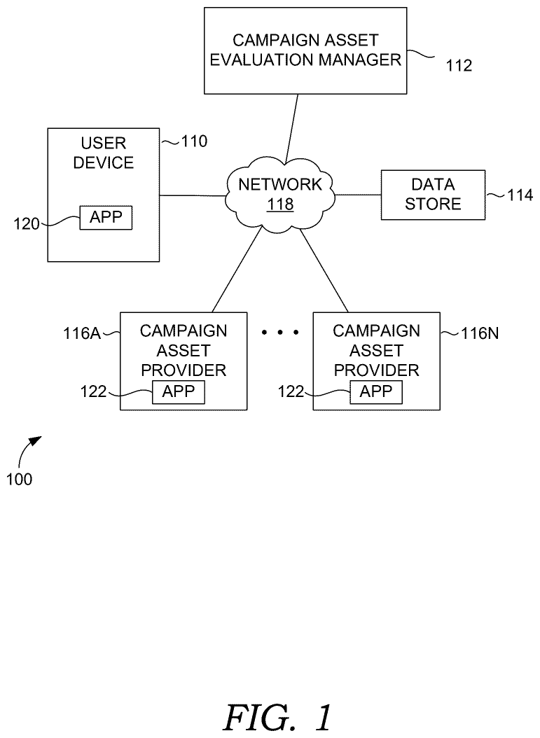

Referring initially to FIG. 1, a block diagram of an exemplary network environment 100 suitable for use in implementing embodiments described herein is shown. Generally, the system 100 illustrates an environment suitable for facilitating identification of audience insights based on persona representations via AI (e.g., an LLM, LVM, and/or MLLM). Among other things, embodiments described herein effectively and efficiently identify audience insights in association with various campaign assets based on persona representations. Thereafter, the audience insights can be used to analyze, evaluate, or select a particular campaign asset(s) to utilize in implementing or executing the campaign. In this regard, candidate campaign assets may be efficiently and effectively analyzed or evaluated in reference to desired or target audience for a particular campaign. In particular, various persona representations associated with a target audience may be identified and used, via AI technology, to analyze a set of campaign assets. The resulting audience insights may be used to select or filter the candidate campaign assets to identify one or more campaign assets for implementation. As persona representations are used in conjunction with AI technology, the evaluation of the various candidate campaign assets is performed efficiently, thereby reducing the computing resource utilization that would otherwise be used to perform testing of various campaign assets over an extensive testing period.

In operation, a user, such as a marketer, can input or provide campaign data and, based on the input, be automatically provided with one or more audience insights related to the campaign data. In embodiments, campaign data includes a goal, a target segment, and/or a campaign asset (e.g., candidate content). The resulting audience insights may be insights related to the performance or effectiveness of the campaign asset. As described herein, various persona representations may be generated and used to generate the audience insight. In this regard, the AI technology can analyze the campaign asset in association with the one or more persona representations to generate an audience insight(s) related to the campaign asset.

The network environment 100 includes a user device 110, a campaign asset evaluation manager 112, a data store 114, and campaign asset providers 116a-116n (referred to generally as campaign asset provider[s] 116). The user device 110, the campaign asset evaluation manager 112, the data store 114, and the campaign asset providers 116a-116n can communicate through a network 118, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and campaign asset providers 116a-116n may be in communication with the campaign asset evaluation manager 112 via a mobile network or the Internet, and the campaign asset evaluation manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another; for example, at least a portion of the campaign asset evaluation manager 112 and/or data store 114 may be integrated with the user device 110 and/or campaign asset provider 116. For instance, a portion of the campaign asset evaluation manager 112 may be integrated with a server in communication with a user device 110 and/or campaign asset provider 116, while another portion of the campaign asset evaluation manager 112 may be integrated with the user device 110 and/or campaign asset provider 116.

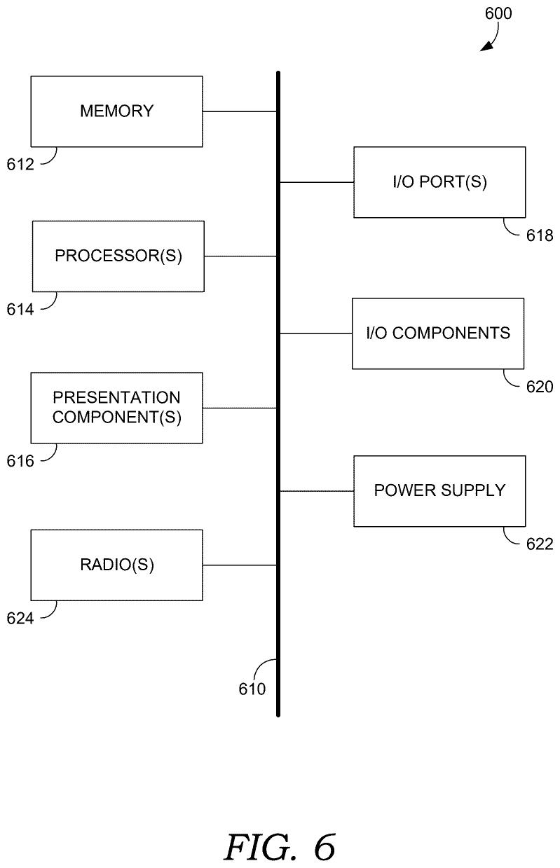

The user device 110 and the campaign asset provider 116 can be any kind of computing device capable of facilitating management of identification of audience insights for campaign assets in accordance with persona representations. For example, in an embodiment, the user device 110 and/or campaign asset provider 116 can be a computing device such as computing device 600, as described above with reference to FIG. 6. In embodiments, the user device 110 and/or campaign asset provider 116 can be a personal computer (PC), a laptop computer, a workstation, a mobile computing device, a personal digital assistant (PDA), a cell phone, or the like. Although illustrated separately, in some cases, the functionality described in association with the user device 110 and the campaign asset provider 116 may be performed via a single device (e.g., the user device also provides the campaign asset[s]).

The user device 110 and/or the campaign asset provider 116 can include one or more processors and one or more computer-readable media. The computer-readable media may include computer-readable instructions executable by the one or more processors. The instructions may be embodied by one or more applications, such as application 120 and/or application 122 shown in FIG. 1. The application(s) may generally be any application capable of facilitating identification of audience insights for campaign assets in accordance with persona representations. In some cases, the application(s), such as application 120, may facilitate providing campaign data in association with a campaign. In some cases, the campaign data may be provided in the form of a campaign brief or a reference thereto. Additionally or alternatively, the application(s), such as application 122, may facilitate providing campaign assets, such as various candidate content associated with a campaign. In some implementations, the application(s) comprises a web application, which can run in a web browser, and could be hosted at least partially server-side (e.g., via campaign asset evaluation manager 112). In addition, or instead, the application(s) can comprise a dedicated application. In some cases, the application is integrated into the operating system (e.g., as a service). As one specific example application, application 120 and/or application 122 may be a content management tool and/or analytics tool (e.g., Adobe® Experience Manager or Adobe® Analytics), or a portion thereof, that enables creation, management, delivery, and/or analysis of content and digital assets. In some cases, such digital experience may be provided across various channels, such as websites, mobile apps, forms, electronic communications, etc. Applications 120 and/or 122 may be accessed via a mobile application, a web application, or the like. Applications 120 and 122 may be the same application or different applications.

User device 110 and/or campaign asset provider 116 can be a client device on a client-side of operating environment 100, while campaign asset evaluation manager 112 can be on a server-side of operating environment 100. Campaign asset evaluation manager 112 may comprise server-side software designed to work in conjunction with client-side software on user device 110 and/or campaign asset provider 116 so as to implement any combination of the features and functionalities discussed in the present disclosure. An example of such client-side software is application 120 on user device 110. Another example of such client-side software is application 122 on campaign asset provider 116. Alternatively, the user device 110 and/or the campaign asset provider 116 may include server-side software. This division of operating environment 100 is provided to illustrate one example of a suitable environment, and it is noted there is no requirement for each implementation that any combination of user device 110, campaign asset evaluation manager 112, and/or campaign asset provider 116 remain as separate entities.

In an embodiment, the user device 110 and/or campaign asset provider 116 is separate and distinct from the campaign asset evaluation manager 112 and the data store 114 illustrated in FIG. 1. In another embodiment, the user device 110 and/or campaign asset provider 116 is integrated with one or more illustrated components. For instance, the user device 110 and/or campaign asset provider 116 may incorporate functionality described in relation to the campaign asset evaluation manager 112. For clarity of explanation, embodiments are described herein in which the user device 110, the campaign asset evaluation manager 112, the data store 114, and the campaign asset providers 116 are separate, while understanding that this may not be the case in various configurations contemplated.

As described, a user device, such as user device 110, can facilitate providing campaign data to campaign asset evaluation manager 112 and, in response, view audience insights associated with one or more campaign assets. A user device 110, as described herein, is generally operated by an individual or set of individuals that desires to provide campaign data for use in assessing one or more campaign assets in association with a set of persona representations. As one example, a user device may be operated by a campaign manager or marketing manager. Such an individual may be affiliated with or a representative of a company associated with the campaign.

In some cases, identification of audience insights in association with a campaign asset(s) may be initiated at the user device 110. For example, a user, such as an administrator or campaign manager, may input, provide, or select a set of campaign data. For instance, a user may input or select, via a user interface, a set of campaign data associated with a campaign. In some cases, a user may navigate to and select a document (e.g., a campaign brief) including campaign data for a campaign and select to upload the document. The campaign data may include any type of data associated with a campaign. Various examples of types of campaign data include goals, objectives, target audience, target channels, campaign assets, etc., and/or indications thereof. Any amount and combination of various campaign data may be included. For example, a first set of campaign data provided via user device 110 for a first campaign may include a goal and a target audience, while a second set of campaign data provided via user device 110 for a second campaign may include a goal and a set of campaign assets. As can be appreciated, in some cases, an administrator, programmer, manager, or other individual affiliated with the campaign may input or select a set of campaign data to use for identifying audience insights.

Although only a single user device 110 is illustrated in FIG. 1, any number of user devices may operate in this environment. For example, a first user device may provide campaign data in association with a first campaign, while a second user device may provide campaign data in association with a second campaign.

An input or selection of campaign data can be provided via an application 120 operating on the user device 110. In this regard, the user device 110, via an application 120, might allow a user (e.g., an administrator) to input, select, or otherwise provide a set of campaign data. The application 120 may facilitate the inputting of campaign data in a verbal form, a textual input form, a document form, etc. Such campaign data may be input at the user device 110 in any manner. For instance, upon accessing a particular application (e.g., a content management application), a user may be presented with, or navigate to, an input tool to input campaign data (e.g., via text input) and a corresponding campaign. As another example, a user may navigate to and select a document that includes campaign data.

The user device 110 can communicate with the campaign asset evaluation manager 112 to provide campaign data and/or request evaluation of a campaign asset(s). In embodiments, for example, a user may utilize the user device 110 to provide a set of campaign data via the network 118. For instance, in some embodiments, the network 118 might be the Internet, and the user device 110 interacts with the campaign asset evaluation manager 112 to provide a set of campaign data for use in evaluating campaign assets. In other embodiments, for example, the network 118 might be an enterprise network associated with an organization. It should be apparent to those having skill in the relevant arts that any number of other implementation scenarios may be possible as well.

The campaign asset provider 116 is generally configured to provide campaign assets to the campaign asset evaluation manager 112. As described, in some cases, a campaign asset for evaluation may be provided by another component (separate from the user device). For example, a user device 110 may be used to provide campaign data and initiate evaluation of a campaign asset, while campaign asset provider 116 may provide one or more campaign assets for evaluation. In some cases, the campaign asset provider 116 may be the campaign asset creator or editor. For example, the campaign asset provider 116 may be operated by an individual, or designer, that creates a campaign asset via application 122. Additionally or alternatively, the campaign asset provider 116 may generate a campaign asset using AI technology. In this way, a prompt may be generated (e.g., based on user input) and provided to AI technology that, in response, generates a promotional content or other campaign asset. As described, the campaign asset provider 116 may generate any amount or type of campaign assets. For example, based on any number of prompts input into AI technology, the campaign asset provider 116 may generate and provide various campaign assets for evaluation by the campaign asset evaluation manager. Any number of campaign asset providers may operate in this environment. For example, a first campaign asset provider may provide a first campaign asset, while a second campaign asset provider may provide a second campaign asset.

In some embodiments, an input or selection of campaign assets can be provided via an application 122 operating on the campaign asset provider 116. In this regard, the campaign asset provider 116, via an application 122, might allow a user to input, select, or otherwise provide campaign assets. The application 122 may facilitate the inputting of content in a verbal form, a textual input form, a document form, a video form, etc. Such campaign assets may be input at the campaign asset provider 116 in any manner. For instance, upon accessing a particular application (e.g., a content management application), a user may be presented with, or navigate to, an input tool to input content (e.g., via text input). As another example, a user may navigate to and select a campaign asset.

The campaign asset provider 116 can communicate with the campaign asset evaluation manager 112 to provide campaign assets. In embodiments, for example, a user may utilize the campaign asset provider 116 to provide campaign assets (e.g., user-generated and/or machine-generated) via the network 118. For instance, in some embodiments, the network 118 might be the Internet, and the campaign asset provider 116 interacts with the campaign asset evaluation manager 112 to provide campaign assets for evaluation in association with one or more persona representations. In other embodiments, for example, the network 118 might be an enterprise network associated with an organization. It should be apparent to those having skill in the relevant arts that any number of other implementation scenarios may be possible as well.

With continued reference to FIG. 1, the campaign asset evaluation manager 112 can be implemented as server systems, program modules, virtual machines, components of a server or servers, networks, and the like. At a high level, the campaign asset evaluation manager 112 manages evaluation of campaign assets in accordance with various persona representations. In operation, and at a high level, the campaign asset evaluation manager 112 can obtain a set of campaign data associated with a campaign, for example, from user device 110 and/or campaign asset provider 116. Using AI models, such as an LLM, LVM, and/or MLLM, audience insights may be generated based on one or more persona representations that correspond with a target audience for a campaign asset. Generally, audience insights provide data or insights into effectiveness of a campaign asset in association with a target audience. In some cases, the audience insights may then be presented and/or used to present results via a user interface, for example, of the user device 110. Such audience insights can additionally or alternatively be transmitted to data store 114 for access by any component managing or executing a campaign. Advantageously, utilizing implementations described herein enables evaluation of campaign assets to be performed in an efficient and accurate manner in accordance with persona representations of a target audience.

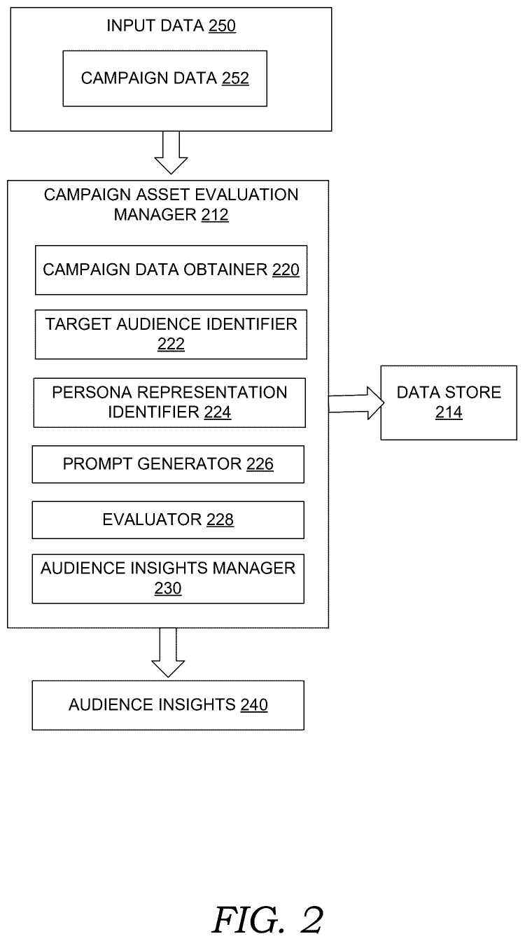

Turning now to FIG. 2, FIG. 2 illustrates an example implementation for facilitating identification of audience insights for campaign assets based on persona representations via campaign asset evaluation manager 212. The campaign asset evaluation manager 212 can communicate with the data store 214. The data store 214 is configured to store various types of information accessible by the campaign asset evaluation manager 212, or other server or component. In embodiments, a user device (such as user device 110 of FIG. 1), a campaign asset provider (such as campaign asset provider 116 of FIG. 1), and campaign asset evaluation manager 212 can provide data to the data store 214 for storage, which may be retrieved or referenced by any such component. As such, the data store 214 may store campaign data, campaign assets, persona representations, audience insights, and/or the like.

In operation, the campaign asset evaluation manager 212 is generally configured to facilitate or manage identification of audience insights for campaign assets based on persona representations. In particular, the campaign asset evaluation manager 212 manages evaluation of performance of campaign assets using persona representations associated with particular target audiences desired for the campaign assets. In this way, various candidate campaign assets may be evaluated for predicted performance or effectiveness in an efficient and effective manner. In embodiments, the campaign asset evaluation manager 212 includes a campaign data obtainer 220, a target audience identifier 222, a persona representation identifier 224, a prompt generator 226, an evaluator 228, and an audience insights manager 230. According to embodiments described herein, the campaign asset evaluation manager 212 can include any number of other components not illustrated. In some embodiments, one or more of the illustrated components 220, 222, 224, 226, 228, and 230 can be integrated into a single component or can be divided into a number of different components. Components 220, 222, 224, 226, 228, and 230 can be implemented on any number of machines and can be integrated, as desired, with any number of other functionalities or services.

The campaign data obtainer 220 is generally configured to obtain campaign data. In this regard, the campaign data obtainer 220 may obtain campaign data 252 as input data 250. As described, in some embodiments, campaign data may be obtained via a user, such as user device 110 of FIG. 1. In this regard, a user may provide campaign data via a user interface of the user device, which then provides the campaign data to the campaign asset evaluation manager (e.g., via a network). In some cases, campaign data may be input, uploaded, or selected via a user interface. Alternatively or additionally, campaign data, such as campaign assets, may be obtained by a campaign asset provider, such as campaign asset provider 116.

In some cases, campaign data can be obtained from a data store, such as data store 214. For example, campaign data may be stored at data store 214 based on campaign data being provided by a user. Thereafter, the campaign data obtainer 220 may obtain campaign data from the data store 214. For instance, the campaign data obtainer may obtain campaign data from the data store 214 based on an input indicating to identify campaign data in association with a campaign, one or more candidate campaign assets, and/or the like. In other instances, the campaign data obtainer 220 may obtain campaign data from the data store 214 based on an occurrence of an event, such as expiration of a time duration. In this regard, campaign data may be obtained from a data store 214 in a periodic manner such that campaign data may be identified in a batch manner, at a downtime of the computing system, etc.

Campaign data generally refers to any data associated with a campaign. Campaign data may include any data that indicates a goal, target audience, a message, a channel, a tactic, a measurement, timing, messaging tone, a campaign asset, etc., associated with a campaign and/or a campaign asset(s). A goal may refer to any goal or objective associated with a campaign and/or a campaign asset(s). Examples of goals may include increasing sales for a particular product, retaining customers, encouraging product use to increase opportunities for renewing subscriptions, etc. A target audience generally refers to a particular group or segment of individuals the campaign is intended to reach. A target audience may be defined by any attribute, such as demographics, interests, behaviors, needs, etc. A message may refer to an idea or value the campaign communicates to inspire or encourage action or interest by an audience member. A channel generally refers to a platform or medium used to deliver a campaign asset(s) (e.g., social media, email, television, print, etc.). A tactic may include specific actions or variations that make up a campaign. A measurement may include a metric or key performance indicator used to track the success of a campaign or campaign asset. Timing may indicate when campaign assets are to be delivered to audience members. A messaging tone refers to generally the tone of the message or campaign asset. A campaign asset may include any asset or material related to a campaign. Generally, a campaign asset may include material or messaging provided to an audience or individuals to engage, persuade, and/or encourage an action. A campaign asset may take on any of a number of forms. In embodiments, a campaign asset is in the form of a content item, such as an image and/or text, that conveys or portrays a message, product, item, etc. Examples of campaign assets include messages, slogans, visual branding (e.g., logos, colors, fonts, etc.), advertisements (e.g., commercials, videos, online advertisements, printed materials, images, etc.), storytelling content, social media content (e.g., blog posts, articles, etc.), and videos.

In embodiments, campaign data is obtained in association with a campaign. In this way, campaign data defined for a campaign may be obtained. In some cases, such campaign data may include campaign assets or candidate campaign assets. In some implementations, campaign data may be included in or defined via a campaign brief. A campaign brief generally serves as a high-level document that provides the overall goals, target audience, messaging, tone, timing, distribution channels, etc., for a campaign. As such, campaign assets, such as social media posts, emails, blog articles, videos, or ads associated with the campaign can align with a unified strategy and contribute to the goals or objectives of the campaign. Each campaign asset included, or to include, in a campaign generally supports the same goal, but may approach the goal differently based on format, platform, or audience segment. In some cases, campaign data may be specific to a single campaign asset, such as a desired candidate content.

The target audience identifier 222 is generally configured to identify a target audience. A target audience indicates a particular audience or group of individuals a brand or organization aims to reach with its campaign, and/or assets associated therewith. A target audience may be defined or indicated based on attributes or characteristics of individuals in an audience, such as demographics, interests, needs, behaviors, past interactions (e.g., with brand), geography, etc., for example, which make them more likely to engage with, benefit from, or purchase a product or service associated with a campaign.

A target audience may be identified in any of a number of ways. In one example, a target audience may be identified based on the campaign data. As described, the campaign data may include an indication of a target audience. In such a case, the target audience identifier 222 may identify or extract the target audience from the campaign data (e.g., via a campaign brief). As another example, a target audience may be identified based on analysis of the campaign data. For example, based on the analysis of the campaign data, the target audience identifier 222 may use or access AI technology, such as an LLM, to identify a target audience that would be suitable for the campaign. By way of example only, assume a campaign brief includes goals for a campaign and other features of the campaign. Such information may be included in a prompt along with an instruction requesting suggestions for a target audience(s) for the campaign. In response, an LLM may identify a subset of customers of a customer base more likely to respond positively to the campaign data and, as such, recommend as a target audience.

Oftentimes, a target audience may include indications of attributes of individuals of a target audience. In this way, a target audience may be considered a subset of a population in which the audience is narrowed down by a specific set of characteristics. In some cases, such a specific set of characteristics may be generally of broad scope, such as a prior customer. For example, a target audience may be defined as an entire customer base. In other cases, a set of characteristics of a target audience may be more specific or detailed. For instance, a target audience may be of a particular gender in a particular geographic location and having a particular interest or interaction history. Although a target audience may generally include one or more indications of attributes, a target audience need not be associated with any particular attribute. For example, a target audience may not be specific to any particular attributes, making it inclusive of an entire population. For instance, in cases in which a content is intended to resonate universally, a target audience may not be restricted to particular attributes.

The persona representation identifier 224 is generally configured to identify a set of persona representations corresponding with the target audience. A persona representation generally refers to a representation or profile of a persona that indicates or characterizes an individual or set of individuals. A persona representation may include a representation of various attributes, such as particular traits, behaviors, and/or characteristics that define how a person or hypothetical person is perceived. For example, a persona representation may include various attributes related to demographic information (e.g., age, gender, geographical location, income, job role, and education level), psychographics (e.g., values, interests, lifestyle, and personality traits), behavioral insights (e.g., purchasing habits, product preferences, and brand interaction patterns), goals and motivation (e.g., what drives engagement with or purchasing of a product), problems or challenges (e.g., that the product or service aims to solve), etc. Various attributes can be used in regard to a persona representation.

In some embodiments, persona representations may be generated based on actual or observed individual data. In this regard, a persona representation may be based on real data and insights associated with an individual's demographics, behavior patterns, motivations, and goals. For example, assume a customer database includes various customer data associated with customers (e.g., in association with a particular organization or product thereof). In such a case, the customer data associated with customers may be used to generate various persona representations. In some cases, the persona representations may be specific to an individual. In this regard, a persona may be generated for a particular customer or individual. For example, assume customer data associated with a customer includes data about the geographical location of a customer, products purchased by the customer, customer communications (e.g., emails, texts, etc.), images or content of interest to the customer, etc. In such a case, a persona representation may be created to represent the customer based on the customer data. In some embodiments, AI technology, such as an LLM, may be used to create or generate a persona from such personal data. For example, various attributes associated with the individual may be provided as input to an LLM and, in response, the LLM may produce a persona representation as desired.

In other cases, persona representations may be generated using various customer data but not specific to a particular individual. For example, a set of customers and corresponding attributes may be provided as input into an LLM and, in response, the LLM may provide various persona representations that correspond with the inputs.

Additionally or alternatively, persona representations may be generated using synthetic data. Synthetic data generally refers to artificially generated data, as opposed to data from actual events and observations. In this regard, persona representations may be generated that reflect realistic characteristics of individuals without using real personal data. Persona representations may be generated using synthetic data in any of a number of ways. As one example, attributes desired for a persona may be identified, for example, based on a target audience, industry research, existing datasets, etc. Such attributes may include demographics (e.g., age, location, income, etc.), psychographics (e.g., interests, values, etc.), behavioral patterns (e.g., buying frequency, preferred channels, etc.), goals or challenges (e.g., relevant to a product), etc. Public datasets, such as census data, market research reports, and/or social media insights may be used to understand general trends and common attributes, for example, within a target market or audience. Accordingly, such public datasets may facilitate generating synthetic persona representations in relevant realistic patterns and demographics. For various attributes, ranges and probabilities may be established. For example, assume an age range of a target audience is 25-40. A probability distribution may be established such that synthetic data generally falls within this age range. Data generation tools or algorithms may be used to create synthetic data points within the defined parameters. In some cases, AI technology, such as Generative Adversarial Networks (GANs) and/or variational autoencoders (VAEs), can be used to produce synthetic data based on statistical properties of real data without any actual user information. Other technologies may additionally or alternatively be used, such as random sampling or data synthesis tools. In accordance with generating a dataset of values, individual data points may be aggregated or combined to generate a persona representation.

In some cases, persona representations are generated or preconfigured and stored in a data store, such as data store 214, for reference by the persona representation identifier 224. For example, as customer data is generated and/or updated, persona representations may be generated and stored in data store 214 (e.g., in a vector form). Additionally or alternatively, personas may be generated in real time. For instance, in accordance with obtaining an input to perform simulated analysis in association with a content(s), a set of persona representations may be generated. As one example, persona representations may be generated (e.g., based on actual data or synthetic data) for individuals associated with a desired or target attribute associated with a target audience. For instance, assume a target attribute specifies a geographical location. In such a case, persona representations may be generated to represent various customers corresponding with the geographical location. In this way, various individuals may be represented for the target geographical location but representing varying features or aspects of the individuals (e.g., different genders, different interests, different ages, etc.). As described, persona representations may be generated in a one-to-one representative manner such that a persona representation is generated for a particular customer associated with the geographical location. Additionally or alternatively, a persona representation may be generated based on a representation of various customers associated with the geographical location based on different attributes and/or common attributes.

The persona representation identifier 224 identifies persona representations for analyzing in association with campaign assets. As described, the identified persona representations may correspond with a target audience to evaluate the campaign assets from the perspective of the target audience. Identifying persona representations in association with a target audience may occur in any number of ways. As one example, a search on a data store, such as data store 214, may be performed (e.g., a keyword search or a semantic search using embeddings) to identify persona representations matching or corresponding with one or more identified attributes of a target audience. For example, assume a target audience includes adults living in a particular geographical location. In such a case, the persona representations may be searched to identify those associated with adults living in the particular geographical location.

As another example, AI technology, such as an LLM, may be accessed or used to identify relevant persona representations. For example, an indication of a target audience (e.g., including desired or target attributes) may be included in a prompt to identify relevant persona representations. In some cases, the prompt may include various persona representations for use by the LLM to identify relevant personas in association with a target audience. In other cases, a retrieval-augmented generation (RAG) approach may be performed to search a data store. For example, the relevant persona representations may be identified and retrieved from a data source, for instance, using a search function or embedding-based similarity search to pull in data that best matches the query (e.g., a target audience). The LLM may then obtain the retrieved information, alongside the prompt or question, and use this combined input to generate a response.

The prompt generator 226 is generally configured to generate an evaluation prompt that may be used to initiate campaign asset evaluation. An evaluation prompt generally refers to an input, such as an input text and/or graphic, that can be provided to an evaluator 228, such as an LLM, LVM, and/or MLLM, to generate an output in the form of audience insights. In embodiments, the evaluation prompt can include content, such as text and/or images, to influence an AI model (e.g., an LLM) to generate an audience insight(s) having a desired content and/or structure. A prompt typically includes text given to an AI model to be completed. In this regard, a prompt generally includes instructions and, in some cases, data to use in performing the analysis. Additionally or alternatively, the evaluation prompt may include images, or other non-text data, to influence an AI model, such as an LVM and/or MLLM, to generate an output having desired content and structure.

In accordance with embodiments described herein, an evaluation prompt may include or reference various types of data. By way of example only, an evaluation prompt may include an instruction or request, a set of persona representations, and/or a campaign asset(s), or references thereto, to be analyzed. An instruction generally refers to a request for performing evaluation of a campaign asset(s), for example, in accordance with one or more persona representations. For instance, an evaluation prompt may include a request to evaluate a campaign asset in accordance with one or more personas. In some cases, an instruction may further indicate a type of audience insight(s) requested. For example, the prompt may request whether a persona representation would purchase a product based on the campaign asset. Other examples of types of audience insights include whether the campaign asset is interesting to the persona representation, whether the campaign asset resonates with the persona representation, whether the persona representation would likely select or purchase an item in association with the campaign asset, whether the persona representation would likely sign up, click on, subscribe, or not unsubscribe based on the campaign asset, whether the campaign asset positively reflects or negatively reflects a product or item, a preferred channel for viewing the campaign asset, etc. In some cases, such a desired or target audience insight may be input or specified by a user, such as a user of user device 110. In other cases, a target audience insight may be a default setting. In yet other cases, a target audience insight may be determined, for example, in association with a goal included in campaign data.

As described, a persona representation(s) may be included in an evaluation prompt to use in evaluation performance or effectiveness of a campaign asset. Any number or type of persona representations may be included in a prompt. As described herein, in some cases, a separate evaluation prompt may be generated for different persona representations. In such a case, the evaluation prompt includes an indication of a single persona representation. Accordingly, for each evaluation prompt, the instruction or request may pertain to how the particular persona representation included in the prompt would evaluate performance of the campaign asset. In this way, a separate evaluation prompt may be generated in association with each persona representation of the persona representations identified as relevant to the target audience. In some cases, a separate evaluation prompt may be generated in association with selected persona representations of the identified relevant persona representations. For example, evaluation prompts may be generated for randomly or selectively selected persona representations.

In other cases, an evaluation prompt may request campaign asset evaluation in association with multiple persona representations and, as such, the evaluation prompt may include an indication of multiple persona representations. For example, the set of identified persona representations, or a subset thereof, may be included in the evaluation prompt for use in evaluating a campaign asset(s). Although described as including a persona representation(s) in the evaluation prompt, in some cases, a persona representation(s) is not included in the prompt. For example, a persona representation(s) may be referenced in the evaluation prompt and/or provided along with the evaluation prompt for use in evaluating content in association therewith.

In some embodiments, a persona representation cluster may be included or referenced in an evaluation prompt. A persona representation cluster generally refers to a representation of a cluster of persona representations. In embodiments, a persona representation cluster may represent or indicate a cluster or group of similar persona representations (e.g., associated with customers) that share common attributes, such as demographics, behaviors, and/or goals. In this regard, rather than obtaining audience insights for each persona representation, a persona representation cluster allows grouping of similar persona representations. As such, the group of similar persona representations may be used for campaign asset evaluation collectively, which may efficiently and effectively analyze a campaign asset(s). For example, clustering persona representations may enable a company to address the needs of different types of customers with more targeted messaging. By grouping persona representations, companies can reduce the number of individual campaigns, thereby focusing instead on one that appeals to the entire cluster.

Persona representation clusters may be generated in any of a number of ways. As described, the clusters may be generated based on a common attribute or characteristic associated with the persona representations. By way of example only, persona representation clusters may be generated based on common attributes of shared demographic or behavioral attributes (e.g., shared age, income level, job role, purchase frequency, preferred channel, etc.), shared goals or challenges (e.g., persona representations associated with similar challenges or shared aligned motivations), etc. Various clustering techniques may be used to perform clustering. For instance, clustering techniques that group customers based on similar characteristics, behaviors, and/or preferences may include K-means clustering, hierarchical clustering, density-based spatial clustering of applications with noise (DBSCAN), Gaussian mixture models (GMM), affinity propagation, self-organizing maps, etc.

In some cases, persona representation clusters may be pre-generated or preprocessed. For example, persona representation clusters may be generated and stored in the data store for reference in generating an evaluation prompt. In other cases, persona representation clusters may be dynamically generated, that is, generated in association with generating an evaluation prompt (e.g., by the prompt generator 226). For example, based on a target audience, goal, or other campaign data, persona representation clusters may be generated. The persona representation clusters may then be generated in association with obtaining the campaign data and included in the evaluation prompt.

By way of example only, assume persona representations are generated and stored in association with customer data for one million customers. In evaluating a campaign asset in association with a target segment, the persona representations may be analyzed and clustered based on attributes associated with the persona representations. As one example, twenty clusters of persona representations may be generated. For instance, assume evaluation of a campaign asset is desired in association with a target segment interested in sports in a particular geographical region. In such a case, the persona representations identified as relevant may include each persona representation corresponding with the particular geographical region and, in some cases, those expressing an interest in sports. Upon identifying relevant persona representations, the persona representations may be clustered based on a type of sport. For example, persona representations may be clustered such that a first cluster of persona representations include an interest in football, a second cluster of persona representations include an interest in swimming, a third cluster of persona representations include an interest in gymnastics, and so on. Such persona representation clusters may be included or referenced in an evaluation prompt. In this way, a reduced number of campaign asset evaluations may be performed, as compared to performing campaign asset evaluations in association with each persona representation. The persona representation cluster may include representative data of the group, aggregated data of the group, etc.

In embodiments, an evaluation prompt may include or reference a campaign asset(s) to evaluate. In some cases, a particular campaign asset may be included or referenced to evaluate for effectiveness or performance. In other cases, multiple campaign assets may be included or referenced for effectiveness of performance. For example, assume five campaign assets are being evaluated in relation to one another and a desired output is to rank the campaign assets or identify a most interesting campaign asset. In such a case, each of the five campaign assets may be included in or referenced by the evaluation prompt. Campaign assets may be in any number of forms. For example, campaign assets may include text, images, videos, and/or any other content that may be viewed.

As can be appreciated, in some embodiments, the evaluation prompt may include additional or alternative data, such as output attributes or additional context. Output attributes generally indicate desired aspects associated with an output, such as audience insights. For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a prompt may include an instruction for a desired number of paragraphs or sentences. As another example, a prompt may include an instruction for a maximum number of characters or a target range of characters. As another example, an output attribute may indicate a format for the response (e.g., a binary response, an answer, and an explanation of reasoning). As another example, an output attribute may indicate a target language for generating the output. For example, the text data may be provided in one language, and an output attribute may indicate to generate the output in another language. Any other instructions indicating a desired output are contemplated within embodiments of the present technology.

Additional context may include any additional information that provides context to the request. Additional context may include a day/time, an indication of a brand, campaign data, a channel of communication of the campaign asset, etc. Any additional context may be provided to indicate or describe the campaign asset, campaign data, etc.

In some embodiments, the prompt generator 226 may be configured to select particular data, such as persona representations, to include in the prompt. As one example, persona representations may be selected to be under a maximum number of tokens required by an evaluator, such as an LLM. For example, assume an LLM includes a 3,000-token limit. In such a case, text data totaling less than the 3,000-token limit may be selected. In this regard, prompts may have a size limit, thereby limiting the number of persona representations included in the prompt. As such, in some cases, using all identified persona representations may not be possible to be used as a prompt to an LLM due to size limitations of an LLM. Hence, it is necessary to select an optimal set of persona representations for feeding to the LLM for obtaining audience insights. Although generally described as using tokens (e.g., pieces of words, individual sets of letters within words, spaces between words, and/or other natural language symbols or characters) for input size, as can be appreciated, other input sizes may be used and may not necessarily be based on token sequence length, but other data size parameters, such as bytes, number of words, etc.

Accordingly, in embodiments, the prompt generator 226 may be configured to select data, such as persona representations, to include in a prompt to generate an audience insight(s). To identify data, such as persona representations, to include, any aspect or score may be used. For example, in some cases, a persona representation score may be generated and used to select persona representations. The score may represent an importance or value associated with the persona representation. Such a score may indicate an extent or measure of some aspect for assessing content to include in the evaluation prompt. For example, a score may indicate relevance to informativeness, diversity, and/or the like. In other cases, persona representations related to a selected or particular persona type may be selected. For instance, in cases in which a particular attribute of a target audience is identified or designated as more valuable or important, a persona representation more largely representing the particular attribute may be identified and used to generate the evaluation prompt.

The prompt generator 226 may format the prompt in a particular form or data structure. One example of a data structure for an evaluation prompt is as follows:

```
{ Instruction to evaluate content
{ Content(s) to evaluate
{ Set of personas to use for evaluating content
  { Persona Representation 1
    ...
  { Persona Representation N
```

Any number of evaluation prompts may be generated. As one example, different evaluation prompts may be generated for different persona representations or different persona clusters (e.g., a first evaluation prompt for a first persona representation and a second evaluation prompt for a second persona representation). As another example, different evaluation prompts may be generated for different campaign assets (e.g., a first evaluation prompt for a first campaign asset and a second evaluation prompt for a second campaign asset). As yet another example, different evaluation prompts may be generated for different audience insights (e.g., a first evaluation prompt for a first type of audience insight and a second evaluation prompt for a second type of audience insight). Further, evaluation prompts may be generated for various combinations. For instance, a first evaluation prompt may be generated for a first campaign asset to be evaluated in association with a first persona representation, a second evaluation prompt may be generated for the first campaign asset to be evaluated in association with a second persona representation, a third evaluation prompt may be generated for a second campaign asset to be evaluated in association with the first persona representation, a fourth evaluation prompt may be generated for a second campaign asset to be evaluated in association with a second persona representation, and so on.

The evaluator 228 is generally configured to evaluate campaign assets and identify or generate audience insights associated therewith. In this regard, the evaluator 228 analyzes campaign assets (e.g., in the form of text and/or images) in association with a persona or a set of personas and outputs one or more audience insights. Stated differently, the evaluator 228 generates or predicts results of effectiveness or performance of a campaign asset(s). In embodiments, the evaluator 228 takes, as input, an evaluation prompt generated by the prompt generator 226. Based on the evaluation prompt, the evaluator 228 can generate a set of audience insights, for example, associated with a campaign asset included or indicated in the prompt. For instance, assume an evaluation prompt includes a candidate campaign asset generated in association with a campaign. In such a case, the evaluator 228 identifies or generates audience insights, such as content effectiveness, based on a persona representation(s) or persona representation cluster(s) included in the evaluation prompt.

The evaluator 228 may be or include any number of AI models or technologies (e.g., generative AI models or technologies). In some embodiments, the AI model is a Large Language Model (LLM). A language model is a statistical and probabilistic tool that determines the probability of a given sequence of words occurring in a sentence (e.g., via next sentence prediction [NSP] or minimal learning machine [MLM]). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

Additionally or alternatively, the evaluator 228 may be in the form of a large vision model (LVM) that can interpret and understand visual information. A visual model may be built using a deep learning technique, such as convolutional neural networks (CNNs) and/or transformer models, which are well-suited for tasks involving image recognition, classification, segmentation, object detection, etc. At a high level, a vision model processes visual data in the form of images or videos by extracting features at various levels of abstraction to understand the content. Vision models learn to recognize patterns, shapes, textures, and other visual cues that are relevant to a task. Examples of vision models include Landing AI's LandingLens and Google's Vision Transformer (ViT).

Further, the evaluator 228 may be in the form of a multimodal large language model (MLLM) that can interpret and understand visual information. An MLLM generally understands and generates text while also processing and comprehending other modalities, such as images, audio, and/or video. MLLM can associate text with various forms of data, thereby enabling such models to perform tasks that require understanding and synthesis across multiple modalities. Examples of MLLMs include Open AI's GPT-4 Turbo with Vision and Open AI's Contrastive Language-Image Pre-training (CLIP).

As such, as described herein, the evaluator 228, in the form of an LLM, LVM, and/or MLLM, can obtain an evaluation prompt and, using such information in the evaluation prompt, generate a set of audience insights(s) for a campaign asset(s). In some embodiments, the evaluator(s) takes on the form of an LLM, LVM, and/or MLLM, but various other AI models can additionally or alternatively be used.

Use of LLM, LVM, and/or MLLM may depend on the format of content to be evaluated. As one example, evaluation prompts including only text may be processed via an LLM, and evaluation prompts including images may be processed via an LVM and/or MLLM. In some cases, text-based prompts and visual-based prompts may be generated separately such that the text-based prompts are processed by an LLM, while the visual-based prompts are processed via an LVM or MLLM. In other cases, prompts with a visual aspect may be directed to an MLLM. In this way, an MLLM may process both the text-based brand guidelines and the visual-based brand guidelines. Accordingly, although the evaluator 228 is illustrated as a single component, any number of components may be used to identify actionable guidelines.

The audience insights manager 230 is generally configured to manage the audience insights. In this regard, audience insights generated via the evaluator 228 may be managed and/or transmitted by the audience insights manager 230. In some cases, in accordance with the evaluator 228 identifying audience insights 240, the audience insights may be stored, for example, in data store 214, for use in performing subsequent campaign asset evaluations, making decisions related to the candidate campaign assets, etc. Additionally or alternatively, audience insights 240 may be provided to a user device or user for viewing, such as via user device 110 of FIG. 1, or another component for viewing or performing further analysis.

Further, the audience insights manager 230 may use the audience insights produced or output by the evaluator 228 to generate or derive additional audience insights. For instance, in some cases, the audience insights may be aggregated or averaged. For example, in identifying content effectiveness in association with different persona representations, the audience insights may be combined or averaged to determine a total effectiveness associated with the campaign asset. As another example, content effectiveness may be identified for different portions or aspects of a campaign asset. In this regard, different effectiveness scores or rankings may be totaled to generate an overall effectiveness score for the campaign asset. Any statistic may be derived from such information (e.g., in association with any number of evaluations).

As another example, the audience insights manager 230 may compare different campaign assets to one another based on audience insights and provide a suggestion or recommendation for a campaign asset to be delivered to customers. For instance, effectiveness associated with multiple candidate campaign assets may be compared to one another or ranked, and the highest effective campaign asset may be recommended or suggested for use.

In some embodiments, the audience insights manager 230 may analyze the audience insights and initiate a new or different evaluation. For instance, based on a response to a first evaluation prompt, the audience insights manager 230 may trigger the prompt generator to generate a new evaluation with a different instruction. By way of example only, assume a response to a first evaluation prompt indicates a persona representation would be unlikely to purchase a product. Based on the response, the audience insights manager 230 may initiate a second evaluation prompt corresponding with the same persona representation to identify a reason for not purchasing the product. On the other hand, if the first evaluation prompt resulted in a likely purchase of a product, a second evaluation prompt may request an indication of if the persona representation would likely pay more for a newer or different version of the product. These examples are directed to modifying the requested audience insight, however embodiments are not so limited and additional evaluation requests may be generated for different persona representations, different campaign assets, etc.

Determining a scope for a new or different evaluation may be performed in any number of ways. In some cases, a pattern, template, or hierarchical structure may be employed to identify a subsequent evaluation to perform. In other cases, AI technology may be used to facilitate generation of a subsequent evaluation scope to pursue.

Audience insights may be presented, via a user interface, in any number of ways. As one example, audience insights may be presented in association with a campaign asset, a target audience, a persona representation(s), a score, etc. In this way, a user may select to view audience insights for a campaign asset associated with a particular target audience(s). For example, a user may select to view audience insights in association with a campaign asset. In response, the user interface may present audience insights associated with the campaign asset.

As can be appreciated, any number or type of audience insights may be generated, and embodiments described herein are not intended to limit the type of audience insights that may be requested or produced via AI technology. Further, various implementations may be used to generate audience insights for a campaign asset(s) in accordance with one or more personas. For example, a single prompt may be generated that includes an indication of a goal, a target audience, and a campaign asset. Based on such data, one or more persona representations may be obtained (e.g., accessed from a data store based on a search, for instance, via RAG implementation) and augmented with the prompt data to identify one or more audience insights associated with the campaign asset. As another example, a prompt may be generated that includes an indication of a goal and a campaign asset with a request to identify a target audience for the campaign asset. Any number of implementations may be employed in accordance with embodiments described herein.

### Exemplary Implementations for Facilitating Identification of Audience Insights Based on Persona Representations Using AI

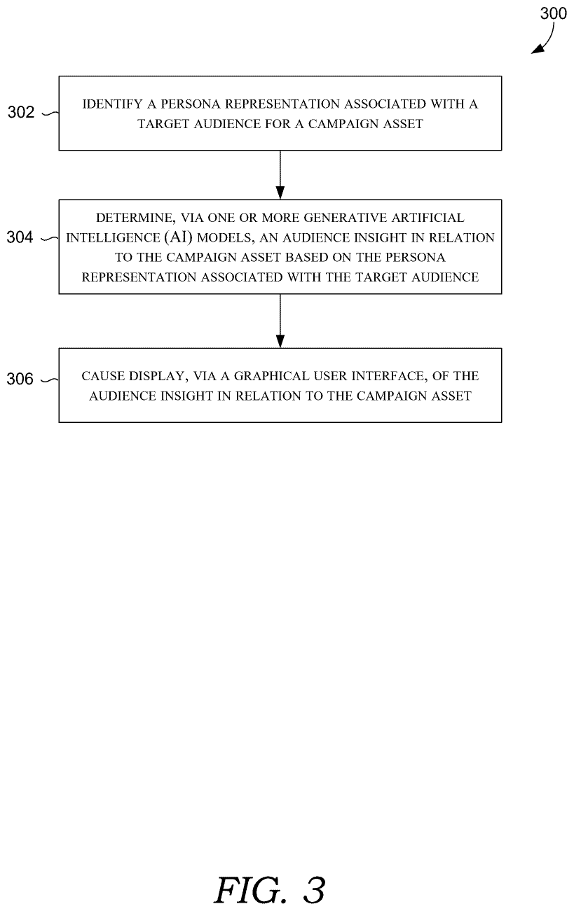

As described, various implementations can be used in accordance with embodiments described herein. FIGS. 3-5 provide methods of facilitating identification of audience insights based on persona representations using AI, in accordance with embodiments described herein. The methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to one implementation of facilitating identification of audience insights based on persona representations using AI, in accordance with embodiments described herein. Initially, at block 302, a persona representation associated with a target audience is identified for a campaign asset. In embodiments, the persona representation is identified as associated with a target audience based on a similarity between a first attribute indicated in the persona representation and a second attribute indicated in the target audience. For example, persona representations may be generated based on a set of customer data. Thereafter, the persona representations may be searched to identify the persona representation including an attribute that matches or is similar to an attribute designated in the target audience. In some cases, to identify the target audience, campaign data is obtained and the target audience is identified therefrom.

At block 304, an audience insight in relation to the campaign asset is determined, via one or more generative artificial intelligence (AI) models, based on the persona representation associated with the target audience. In some implementations, an evaluation prompt is generated for input into the AI model. For example, an evaluation prompt may be generated that includes an indication of the persona representation, an indication of the campaign asset, and an indication of a type of desired audience insight.

At block 306, the audience insight is displayed, via a graphical user interface, in relation to the campaign asset. In embodiments, the audience insight indicates an effectiveness or a performance of the campaign asset in accordance with the persona representation. In some cases, the audience insight may be aggregated with a set of audience insights generated for the campaign asset in accordance with a set of persona representations. In such cases, the aggregation of data may be provided for display to a user.

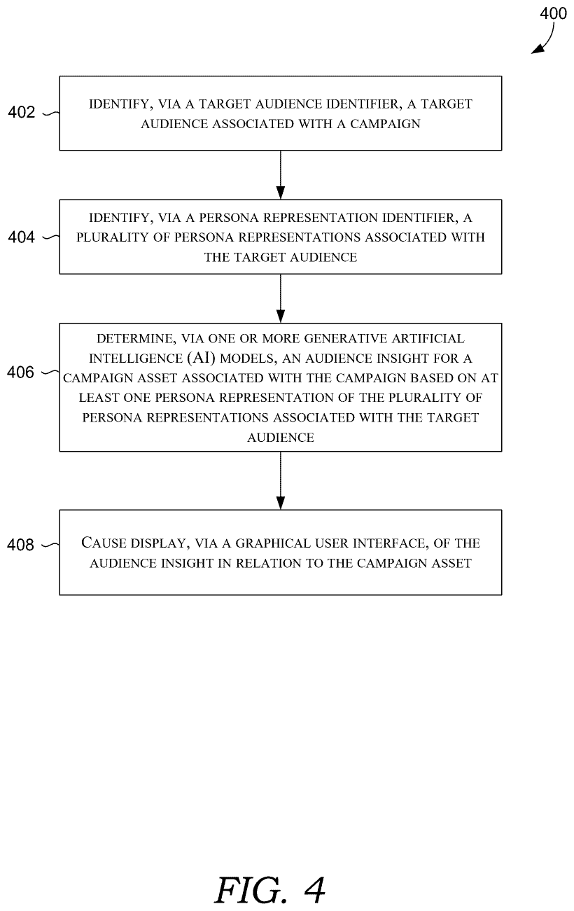

Turning to FIG. 4, method 400 of FIG. 4 is directed to another example implementation of facilitating identification of audience insights based on persona representations using AI, in accordance with embodiments described herein. Initially, at block 402, a target audience associated with a campaign is identified. In embodiments, the target audience is identified based on analysis of a campaign brief for the campaign.

At block 404, a plurality of persona representations associated with the target audience is identified. In embodiments, the plurality of persona representations are generated based on a set of customer data. In some cases, each persona representation represents a particular customer.

At block 406, an audience insight is determined for a campaign asset associated with the campaign based on at least one persona representation of the plurality of persona representations associated with the target audience. The audience insight may indicate effectiveness or performance of the campaign asset as perceived by a persona representation(s). In embodiments, the audience insight is determined based on a persona representation cluster that groups a set of persona representations based on at least one similar attribute (e.g., a demographic, an interest, a user interaction, etc.). The audience insight for the campaign asset may be determined by providing, as input, an evaluation prompt into an AI model(s). Such a prompt may include an indication of the campaign asset, an indication of a persona representation(s), etc.

At block 408, the audience insight is displayed in relation to the campaign asset. For example, the audience insight may be presented to a user that requests to view audience insights in association with the campaign asset.

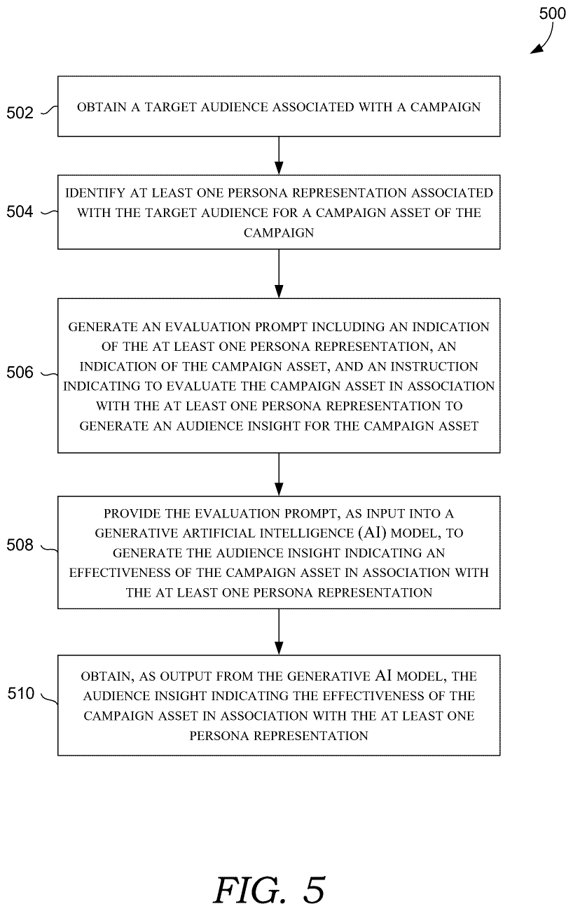

With reference now to FIG. 5, method 500 of FIG. 5 is directed to another example implementation of facilitating identification of audience insights based on persona representations using AI, in accordance with embodiments described herein. At block 502, a target audience associated with a campaign is obtained. The target audience may be identified in any number of ways. For example, a target audience may be identified based on an analysis of a campaign brief for the campaign.

At block 504, at least one persona representation associated with the target audience for a campaign asset of the campaign is identified. In some cases, the persona representation is selected from a plurality of persona representations generated using a set of customer data. As such, the plurality of persona representations may be searched to identify at least one persona representation relevant to the target audience.

At block 506, an evaluation prompt is generated that includes an indication of a persona representation(s), an indication of a campaign asset, and an instruction indication to evaluate the campaign asset associated with the campaign based on at least one persona representation of the plurality of persona representations associated with the target audience. The evaluation prompt may include other types of data, such as an indication of a type of audience insight to generate.

At block 508, the evaluation prompt is provided as input into an AI model to generate an audience insight. In embodiments, the AI model may be or include an LLM. At block 510, the audience insight indicating the effectiveness of the campaign asset in association with at least one persona representation is obtained as output from the AI model. The audience insight may be presented for display. In some cases, the audience insight may be combined or aggregated with other audience insights associated with the campaign asset and the aggregated audience insights provided for display to a user.

### Overview of an Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein, and nor should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or non-volatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

1. One or more computer storage media having computer-executable instructions embodied thereon that, when executed by one or more processors, cause the one or more processors to perform a method, the method comprising:
identifying a persona representation associated with a target audience associated with a goal for a campaign asset;
determining, via one or more generative artificial intelligence (AI) models, an audience insight in relation to the campaign asset based on the persona representation associated with the target audience;
causing display, via a graphical user interface, of the audience insight in relation to the campaign asset; and
using the audience insight in relation to the campaign asset and audience insights associated with other campaign assets to filter candidate campaign assets to identify the campaign asset to implement to attain the goal prior to serving the campaign asset over a network, thereby reducing computer resource utilization.

2. The media of claim 1, wherein the persona representation is identified as associated with the target audience based on a similarity between a first attribute indicated in the persona representation and a second attribute indicated in the target audience.

3. The media of claim 1, further comprising:
obtaining campaign data; and
identifying the target audience using the campaign data.

4. The media of claim 1, further comprising:
generating, via the one or more generative AI models, the persona representation based on a set of customer data; and
storing the persona representation in a data store.

5. The media of claim 1, further comprising:
generating an evaluation prompt that includes an indication of the persona representation, an indication of the campaign asset, and an indication of a type of desired audience insight; and
providing the evaluation prompt as input to the one or more generative AI models.

6. The media of claim 1, wherein the audience insight indicates an effectiveness or a performance of the campaign asset in accordance with the persona representation.

7. The media of claim 1, further comprising:
aggregating the audience insight with a set of audience insights generated for the campaign asset in accordance with a set of persona representations; and
providing the aggregation of the audience insight with the set of audience insights for display via the graphical user interface.

8. The media of claim 1, further comprising:
generating a set of persona representations based on a set of customer data; and
searching the set of persona representations to identify the persona representation associated with the target audience for the campaign asset.

9. A computer-implemented method comprising:
identifying, via a target audience identifier, a target audience associated with a campaign;
identifying, via a persona representation identifier, a plurality of persona representations associated with the target audience;
determining, via one or more generative artificial intelligence (AI) models, an audience insight for a campaign asset associated with the campaign based on at least one persona representation of the plurality of persona representations associated with the target audience;
causing display, via a graphical user interface, of the audience insight in relation to the campaign asset; and
using the audience insight for the campaign asset and audience insights associated with other campaign assets to identify, from a set of candidate campaign assets, the campaign asset to communicate in association with the campaign.

10. The method of claim 9, wherein the target audience is identified based on analysis of a campaign brief for the campaign.

11. The method of claim 9, further comprising generating the plurality of persona representations based on a set of customer data, wherein each persona representation represents a particular customer.

12. The method of claim 9, wherein the audience insight for the campaign asset is determined based on a persona representation cluster that groups a set of persona representations based on at least one similar attribute.

13. The method of claim 9, wherein the audience insight for the campaign asset is determined by providing, as input, an evaluation prompt into the one or more generative AI models, the evaluation prompt including an indication of the campaign asset and an indication of the at least one persona representation associated with the target audience.

14. The method of claim 9, wherein the audience insight indicates an effectiveness of the campaign asset as perceived by the at least one persona representation.

15. A computing system comprising:
a processor; and
one or more computer storage media storing computer-useable instructions that, when used by the one or more processors, causes the one or more processors to perform operations comprising:
obtaining a target audience associated with a campaign;
identifying at least one persona representation associated with the target audience for a campaign asset of the campaign;
generating an evaluation prompt including an indication of the at least one persona representation, an indication of the campaign asset, and an instruction indicating to evaluate the campaign asset in association with the at least one persona representation to generate an audience insight for the campaign asset;
providing the evaluation prompt, as input into a generative artificial intelligence (AI) model, to generate the audience insight indicating an effectiveness of the campaign asset in association with the at least one persona representation;
obtaining, as output from the generative AI model, the audience insight indicating the effectiveness of the campaign asset in association with the at least one persona representation; and
using the audience insight for the campaign asset and audience insights associated with other campaign assets to identify, from a set of candidate campaign assets, the campaign asset to communicate in association with the campaign.

16. The system of claim 15, wherein the evaluation prompt includes an indication of a type of audience insight to generate.

17. The system of claim 15, further comprising providing, for display via a user interface, the audience insight.

18. The system of claim 15, further comprising:
aggregating the audience insight with at least one other audience insight associated with the campaign asset; and
providing the aggregated audience insights associated with the campaign asset for display via a user interface.

19. The system of claim 15, further comprising:
generating a plurality of persona representations based on a set of customer data, wherein each persona representation represents a particular customer; and
identifying the at least one persona representation by searching the plurality of persona representations.

20. The system of claim 15, further comprising identifying the target audience based on analysis of a campaign brief for the campaign.
